(19) United States
(12) Patent Application Publication
(10) Pub. No.: US 2007/0227057 A1
(43) Pub. Date: Oct. 4, 2007

(54) Method and apparatus for ice fishing

(76) Inventor: John Holmberg, Blaine, MN (US)

Correspondence Address: CYR & ASSOCIATES, P.A., PONDVIEW PLAZA, 5850 OPUS PARKWAY SUITE 114, MINNETONKA, MN, 55343, US

(21) Appl. No.: 11/390,571

(22) Filed: Mar. 28, 2006

(51) Int. Cl. A01K 97/12

(52) U.S. Cl. 43/17

(57) ABSTRACT

Devices according to the present invention are signaling device for ice fishing. The signaling device is generally configured to display an indicator, such as a flag, in response to a force applied to a fishing line by a fish. At least a portion of the device includes a phosphorescent material. This phosphorescent material emits light in response to a stimulus such as a light source and continues to emit light for time periods ranging from several minutes to several hours following the removal of the stimulus. Inclusion of the phosphorescent material increases the signaling capability as well as the overall visibility of the device in low light conditions.

### BACKGROUND OF THE INVENTION

1. Field of the Invention

The present invention relates to an ice fishing tip-up device having improved visibility.

2. Description of the Related Art

Various signaling devices have been used for ice fishing that visually indicate to an ice fisherman that a fish has been taken on a particular fishing line. These devices include a base, a visual indicator attached to the base, various mechanical detents attached to the base, and fishing line secured to the base through an assembly which includes a reel or other spooling device and configured such that the fishing line is in communication with the detent. The visual indicator is postionable between at least a ready position and a signaling position. The indicator is held in the ready position by the detent, and the detent is configured to release the visual indicator in response to a force applied to the fishing line by a fish. Upon release from the detent, the indicator moves from the ready position into the signaling position. A typical indicator configuration is a flag on a mast where the mast is secured to the base by a spring. The mast is bent over and held in a ready position by the detent. When the detent releases the mast, the mast springs into an upright signaling position that indicates to the ice fisherman that a fish may be on the fishing line.

Ice fishermen often use several such devices simultaneously so as to fish over a wide area. Ice fishermen sometimes fish at night. The weather may be inclement. Even in the daytime, inclement winter weather can create low light conditions and otherwise obscure a fisherman's vision. There may be snowdrifts around the device. As a result, it can be difficult for an ice fisherman to see whether the indicator is in the signaling or ready position. In dark or inclement weather, it can be difficult for an ice fisherman to even see the indicator or to find the devices when the devices are scattered over a wide area. Battery powered electric lights have been attached to indicators in order to solve these problems. However, battery powered devices require a certain amount of maintenance and related ongoing expense as the batteries and, possibly, the light bulbs require replacement from time to time. Such devices are also subject to corrosion and breakage and may otherwise fail. Thus, there is a need for a signaling device for ice fishing with a signal that is visible in low light and inclement weather conditions, that is durable, and that does not require maintenance.

### SUMMARY OF THE INVENTION

Apparatus and methods in accordance with the present invention may resolve many of the needs and shortcomings discussed above and will provide additional improvements and advantages as will be recognized by those skilled in the art upon review of the present disclosure by providing signaling devices for ice fishing having visibility in low light and inclement weather conditions.

Signaling devices for ice fishing according to the present invention have a base configured to extend across at least a portion of a hole formed in ice. A fishing line retention assembly is secured to the base, and a fishing line may be secured to the fishing line retention assembly. An indicator is also secured to the base with at least a portion of the indicator extendable relative to the base. A moveable indicator detent is secured to the base to retain the indicator in at least a ready position. The indicator detent is in communication with the fishing line retention assembly. The indicator detent is configured to release the indicator to at least a signaling position in response to a force applied to the fishing line retention assembly. At least a portion of the indicator or at least a portion of the base includes a phosphorescent material that continues to emit light for time periods ranging from several minutes to several hours following the removal of the source of stimulus.

The apparatus of the current invention will also provide additional improvements and advantages for ice fishing that will be recognized by those skilled in the art upon review of the following detailed description of various exemplary embodiments of the present invention.

### BRIEF DESCRIPTION OF THE DRAWINGS

The present invention will be illustrated and described with reference to the drawings of preferred embodiments and will be clearly understood in details.

FIG. 1 illustrates an embodiment of the device according to the present inventions where the rectangular base is placed over a hole in the ice so as to be supported by the ice surrounding the hole, the indicator is in the signaling position, and the indicator and the base include phosphorescent material;

FIG. 2A illustrates a side view of an embodiment of the device having a rectangular base with the indicator held in the ready position by the indicator detent, and the indicator and the base incorporate phosphorescent material;

FIG. 2B illustrates a top view of an embodiment of the device having a rectangular base with the indicator held in the ready position by the indicator detent;

FIG. 3A illustrates an embodiment of the device having a circular base with the indicator in the signaling position, and the phosphorescent material incorporated in the indicator;

FIG. 3B illustrates an embodiment of the device having a circular base with the indicator held in the ready position by the indicator detent, and the phosphorescent material incorporated in the indicator;

FIG. 4A illustrates an embodiment of the indicator where the indicator is configured as a mast having a marker configured as a rectangular flag;

FIG. 4B illustrates an embodiment of the indicator where the indicator is configured as a mast having a marker configured as a pennant;

FIG. 4C illustrates an embodiment of the indicator where the indicator is configured as a mast having a marker configured as a sphere;

FIG. 5A illustrates a cross-section of an embodiment of the base where the base is constructed from a non-phosphorescent material and the base has a phosphorescent coating;

FIG. 5B illustrates a cross-section of an embodiment of the base where the base is constructed from a non-phosphorescent material and the base has a phosphorescent coating and a translucent coating;

FIG. 5C illustrates a cross-section of an embodiment of the base where the base is constructed from a phosphorescent polymer;

FIG. 5B illustrates a cross-section of an embodiment of the base where the base is constructed from a phosphorescent polymer and has a translucent coating;

FIG. 6A illustrates a cross-section of an embodiment of an indicator having a marker where the marker is constructed from a non-phosphorescent material and has a phosphorescent coating;

FIG. 6B illustrates a cross-section of an embodiment of an indicator having a marker where the marker is constructed from a non-phosphorescent material and has a phosphorescent coating and a translucent coating;

FIG. 6C illustrates a cross-section of an embodiment of an indicator having a marker where the marker is constructed from a phosphorescent polymer;

FIG. 6D illustrates a cross-section of an embodiment of an indicator having a marker where the marker is constructed from a phosphorescent polymer and has a translucent coating;

FIG. 7A illustrates a cross-section of an embodiment of an indicator having a mast where the mast is constructed from a non-phosphorescent material and has a phosphorescent coating;

FIG. 7B illustrates a cross-section of an embodiment of an indicator having a mast where the mast is constructed from a non-phosphorescent material and has a phosphorescent coating and a translucent coating;

FIG. 7C illustrates a cross-section of an embodiment of an indicator having a mast where the mast is constructed from a phosphorescent polymer; and, FIG. 7D illustrates a cross-section of an embodiment of an indicator having a mast where the mast is constructed from a phosphorescent polymer and has a translucent coating;

All Figures are illustrated for ease of explanation of the basic teachings of the present invention only; the extensions of the Figures with respect to number, position, relationship and dimensions of the parts to form the embodiment will be explained or will be within the skill of the art after the following description has been read and understood. Further, the exact dimensions and dimensional proportions to conform to specific force, weight, strength, flow and similar requirements will likewise be within the skill of the art after the following description has been read and understood. Where used in various Figures, the same numerals designate the same or similar parts. When the terms “top,” “bottom,” “right,” “left,” “forward,” “rear,” “first,” “second,” “inside,” “outside,” and similar terms are used, the terms should be understood to reference only the structure illustrated in the Figures and utilized only to facilitate describing the illustrated embodiments.

### DETAILED DESCRIPTION OF THE INVENTION

The present inventions provide a signaling device for ice fishing. Devices according to the present invention may provide visibility to the signaling device when the signaling device is used in low light conditions such as may be encountered at night and other low light conditions such a those that may occur during inclement weather.

Reference will now be made to various embodiments of the invention for the purpose of promoting an understanding of the principles of the invention. It will, nevertheless, be understood that no limitation of the scope of the invention is thereby intended. Alterations, further modifications, and further applications of the principles of the invention are contemplated as would normally occur to one skilled in the art to which the invention relates.

In some aspects, a device 20 according to the present invention consists of a base 30 configured to extend across at least a portion of a hole 34 formed in ice 33. The base 30 includes a fishing line retention assembly 36. An indicator 42 is secured to the base 30, the indicator 42 being positionable between at least a ready position 52 and a signaling position 56 in which at least a portion of the indicator 42 is extended relative to the base 30. An indicator detent 48 is movably secured to the base 30. The indicator detent 48 retains the indicator 42 in at least a ready position 52. The indicator detent 48 is in communication with the fishing line retention assembly 36 and is configured to release the indicator 42 to at least a signaling position 56 in response to a force applied to the fishing line 40 by a fish and transmitted by the fishing line 40 to the fishing line retention assembly 36. The device 20 also includes a phosphorescent material 64 that emits light after absorbing a stimulus such as ultraviolet radiation and continues to emit light for time periods ranging from several minutes to several hours following the removal of the source of such stimulus. At least a portion of the indicator 42 or at least a portion of the base 30 includes the phosphorescent material 64.

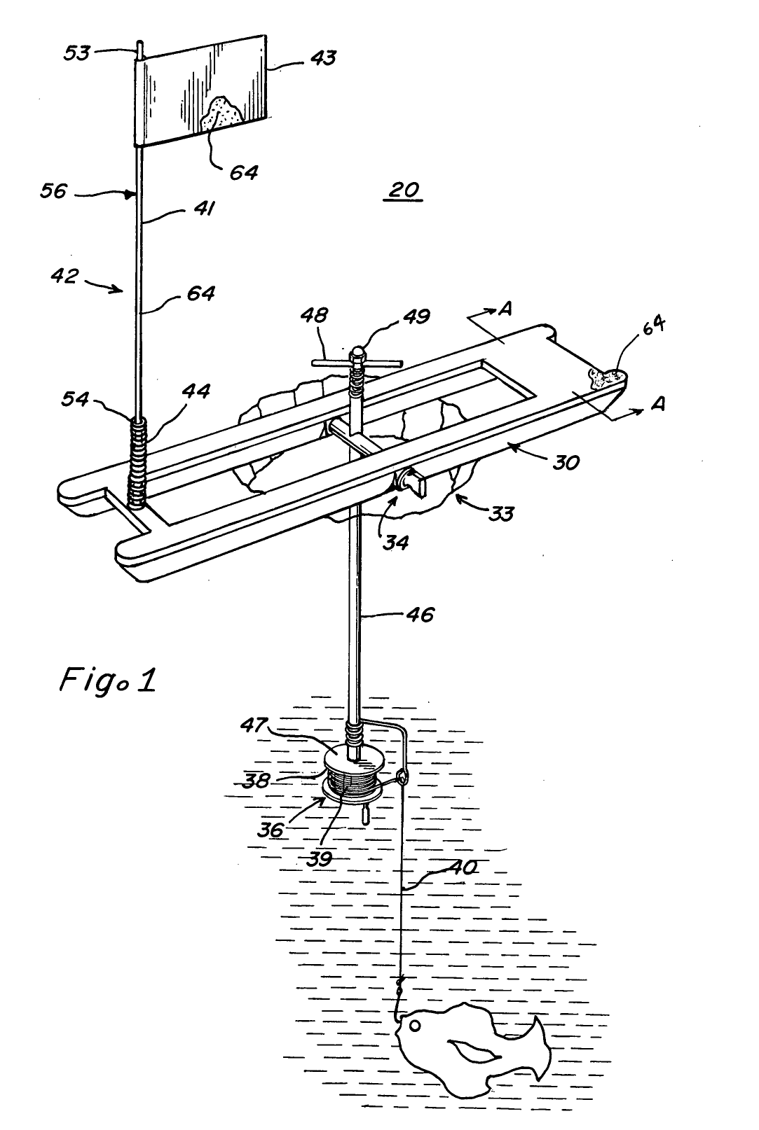

Devices according to the present invention 20 are generally illustrated throughout FIGS. 1-7. The particular exemplary embodiments of the device 20 illustrated in the Figures have been chosen for ease of explanation and understanding of various aspects of the present inventions. These illustrated embodiments are not meant to limit the scope of coverage but only to assist in understanding the context of the language used in this specification and the appended claims. Accordingly, variations of the device 20 different from the illustrated embodiments may be encompassed by the appended claims.

As illustrated generally throughout the Figures, a device 20 according to the present invention consists of a base 30 configured to extend across at least a portion of a hole 34 formed in ice 33, a fishing line retention assembly 36, a fishing line 40, an indicator detent 42, a connector 46, and an indicator 42. The fishing line retention assembly 36 is connected to the base 30 and is configured to retain a fishing line 40. An indicator 42 is secured to the base 30. The indicator 42 is configured so as to be positionable between at least a ready position 52 and a signaling position 56 with respect to the base 30. A movable indicator detent 48 retains the indicator 42 in the ready position 52. A connector 46 secured between the fishing line retention assembly 36 and the indicator detent 48 communicates forces between the fishing line retention assembly 36 and the indicator detent 48. When a fish is taken on the fishing line 40, the connecter 46 moves the indicator detent 48 thereby releasing the indicator 42 in response to a force applied to the fishing line retention assembly 36 by the attached fishing line 40. When the indicator 42 is released from the indicator detent 48, the indicator 42 assumes a signaling position 56 with respect to the base 30. In addition, inventions according to the present disclosure include a phosphorescent material 64. This phosphorescent material 64 may be included in at least a portion of the base 30 and may be included in at least a portion of the indicator 42.

The base 30 may have a generally circular or rectangular geometry, and may be designed to span a hole 34 formed in the ice 33 so as to be supported by the ice 33 adjacent to the hole 34. Alternatively, the base 30 may be designed to be received within a hole 34 formed in the ice 33 and to be floatably supported within the hole 34 formed in the ice 33. In various embodiments, the base 30 may extend across a large portion of the hole 34 so as to insulate the hole 34, thereby inhibiting ice 33 formation in the hole 34.

The base 30 may be formed from wood, polymer, or other materials. The base 30 may include a phosphorescent material 64. A base 30 formed from wooden or polymeric material may be coated with a coating material 72 such as a paint containing a phosphorescent material 64. Alternatively, the base 30 may be formed from a polymer 68 having a phosphorescent material 64 incorporated into the polymer 68. A base 30 that includes a phosphorescent material 64 may have a coating of translucent material 76 applied such that the translucent material 76 overlies the phosphorescent material 64 so as to protect the phosphorescent material 64 from abrasion, oxidation, and other forms of deterioration.

The fishing line retention assembly 36 may be a fishing reel 38, a spool, or other device configured to receive a fishing line 40. Typically, the fishing line retention assembly 36 may be generally configured so as to allow the fishing line 40 to be wound upon or unwound from the fishing line retention assembly 36. The fishing line retention assembly 36 may also be generally configured such that application of a force to the attached fishing line 40 by a fish would cause the fishing line retention assembly 36 to rotate.

The indicator 42 may include an elongated mast 41 having a marker 43 secured thereto, where the marker may be a flag, banner, pennant, spherical or other shaped object, or other visual element as would be recognized by one skilled in the art. The mast 41 may have a telescoping construction and may be secured to the base by a mast connector 44 where the mast connector 44 may be a spring, a length of rubber tubing, or other such elastic element so as to allow the mast 41 to move between a ready position 52 and a signaling position 56. The mast 41 may incorporate a variety of colorations, combinations of colors, and color patterns so as to distinguish between individual devices 20 and distinguish between sets of devices 20.

The marker 43 may be made from a rigid material, a compliant material, or combination thereof. The marker 43 may be substantially a two-dimensional structure such as a flag and may have a variety of two-dimensional geometric shapes including rectangular, circular, and triangular as well as irregular shapes. The marker 43 may also be a three-dimensional structure such as a ball, and the marker 43 may have any of a variety of three-dimensional geometric shapes. The marker 43 may be configured so as to slip over the mast 41. The marker 43 may be configured to clip onto the mast 41. The marker 43 may be molded to the mast 41. The marker 43 may incorporate a variety of colorations, combinations of colors, and color patterns so as to distinguish between individual devices 20 and distinguish between sets of devices 20.

A phosphorescent material 64 may be incorporated into the indicator 42 or into portions of the indicator 42. The phosphorescent material 64 may be incorporated into the indicator 42 as a coating 72 or as a component of the material or materials from which the indicator 42 is composed or by applying a phosphorescent tape or other adherent containing the phosphorescent material 64. For example, the phosphorescent material may be incorporated into the mast 41 and the phosphorescent material 64 may be incorporated into the marker 43. Portions of the indicator 42 may be formed from a polymer, fabric, or other material having the phosphorescent material 64 incorporated into the polymer or other material. Portions of the indicator 42 may be formed from a fabric or other material where the fabric is treated with a dye containing the phosphorescent material 64. In addition, portions of the indicator 42 may be coated with a translucent material 76 such that the translucent material 76 overlies the phosphorescent material 64 so as to protect the phosphorescent material 64 from abrasion, oxidation, and other forms of deterioration.

The indicator detent 48 is movably secured to the base 30. The indicator detent 48 retains the indicator 42 in at least a ready position 52. The indicator detent 48 is in communication with the fishing line retention assembly 36 by a connector 46 and is configured to release the indicator 42 from the ready position 52 in response to a force applied to the fishing line retention assembly 36 so that the indicator 42 may assume the signaling position 56.

The connector 46 is secured between the fishing line retention assembly 36 and the indicator detent 48. The connector 46 communicates forces between the fishing line retention assembly 36 and the indicator detent 48 so as to cause the indicator detent 48 to disengage the indicator 42 in response to a force imparted to the fishing line retention assembly 36 by a fish tugging on the attached fishing line 40.

In various embodiments, the connector 46 may have the form of a circular shaft, the indicator detent 48 may be configured as an arm secured to the connector 46, the fishing line retention assembly 36 may be a reel 38 having a barrel 39, and the indicator 42 may be configured as a mast 41 with a marker 43 in the form of a flag secured to a first end of the mast 41 and a mast connector 44 in the form of an elastic member such as a spring or length of rubber tubing secured to the second end 54 of the mast 41, with the mast connector 44 also being secured to the base 30. The indicator 42 is placed in the ready position 52 by bending the mast 41 about the mast connector 44 and engaging the mast 41 with the indicator detent 48 so that the indicator detent 48 retains the mast 41 in the ready position 52. Then, a force imparted to the fishing line 40 by a fish causes the barrel 39 of the fishing reel 38 to rotate, which, in turn, causes the connector 46 to rotate. The indicator detent 48 mounted to the end of the connector 46 then rotates so as to disengage from the mast 41, thereby allowing the mast 41 to assume the signaling position 56 so as to display the marker 43 secured to the first end 53 of the mast 41.

Devices 20 according to the present invention also include a phosphorescent material 64 that emits light after absorbing ultraviolet radiation or other stimulus and continues to emit light for some time periods ranging from several minutes to several hours following the removal of the source of such stimulus. This phosphorescent material 64 may be secured to the base 30, to the indicator 42, or to both the base 30 and the indicator 42. A variety of phosphorescent materials 64 are known in the art. Examples of phosphorescent materials 64 include sulfide phosphorescent phosphors such as CaS:Bi (which emits light of violet blue), CaSrS:Bi (which emits light of blue), ZnS:Cu (which emits light of green) and ZnCdS:Cu (which emits light of yellow or orange). A radioactive substance may be doped to these sulfide phosphorescent phosphors so that the phosphorescent phosphor emits light by absorbing the energy of radiation from the radioactive substance.

Examples of phosphorescent materials 64 that may be advantageous according to the present invention 20 include compounds expressed by MAl₂O₄ in which M is at least one metal element selected from a group consisting of calcium, strontium and barium to which magnesium is added. In one form, 0.001 mol % to 10 mol % of europium may be doped to the matrix expressed by MAl₂O₄as an activator in terms of mol % relative to the metal element expressed by M. In another form, 0.001 mol % to 10 mol % of at least one element selected from a group consisting of lanthanum, cerium, praseodymium, neodymium, samarium, gadolinium, terbium, dysprosium, holmium, erbium, thulium, ytterbium, lutetium, manganese, tin and bismuth may be doped to the compound expressed by MAl₂O₄ as a co-activator in terms of mol % relative to the metal element expressed by M. Additional phosphorescent materials 64 that may also be advantageous according to the present invention include a matrix expressed by M₁₋ₓAl₂O₄₋ₓ in which in which M is at least one metal element selected from a group consisting of calcium, strontium and barium, wherein europium is doped to said matrix as an activator and at least one element selected from a group consisting of cerium, praseodymium, neodymium, samarium, terbium, dysprosium, holmium, erbium, thulium, ytterbium and lutetium is doped to said matrix as a co-activator.

The phosphorescent material 64 may be incorporated into a polymer so as to form a polymer incorporating the phosphorescent material 68. Examples of polymers that may be used to incorporate a phosphorescent material 64 would include polycarbonates, polyethylenes, polypropylenes, polystyrenes, polyurethanes, copolymers of ethylene, copolymers of vinyl acetate, terpolymers of acrylonitrile, terpolymers of butadiene and terpolymers of styrene.

The phosphorescent material 64 may also be incorporated into a coating material such as a polyurethane paint so as to form a phosphorescent coating material 72. The phosphorescent coating material 72 may then be applied to the device 20.

The phosphorescent material 64 may also be incorporated into a tape 74. The tape 74 can be a multi-layer film typically consisting of a phosphorescent material 64 backing, an adhesive and a liner, and may be affixed to the device 20 using known methods.

FIG. 1 illustrates an embodiment of a device 20 according to the present inventions where the device 20 is placed over a hole 34 in the ice 33 so as to be supported by the ice 33 surrounding the hole 34. In this embodiment, the fishing line retention assembly 36 is configured as a fishing reel 38 with a barrel 39. A fishing line 40 is secured to the fishing line retention assembly 36 and the fishing line 40 extends from the fishing line retention assembly 36. The connector 46 is configured as a shaft, the connector first end 47 is secured to the barrel 39 of the fishing reel 38 that forms the fishing line retention assembly 36 such that the connector 46 rotates when the barrel of the reel 38 rotates. An indicator detent 48 is secured near a connector second end 49, the indicator detent 48 being configured as two arms oriented so as to be substantially transverse to the connector 46. The indicator 42 is a mast 41 with a marker 43 configured as a flag secured to a first end 53 and a mast connector 44 in the form of a spring secured to the second end 54, with the mast connector 44 also secured to the base 30. The indicator 42, as illustrated, is released from the indicator detent 48 so as to be in the signaling position 56 in FIG. 1. Also, in FIG. 1, the marker 43, the mast 41, and the base 30 all incorporate a phosphorescent material 64.

In the embodiment illustrated in FIGS. 2A and 2B, the indicator 42 is configured as a mast 41 with a marker 43 having the form of a flag secured to the mast first end 53. The fishing line retention assembly 36 is configured as a fishing reel 38, which has a barrel 39. The indicator 42, in this embodiment, may be placed in the ready position by bending the mast 41 about the mast connector 44 and engaging the mast 41 with the indicator detent 48 so that the indicator detent 48 retains the indicator 42 in the ready position 52. Then, a force imparted to the fishing line 40 by a fish causes the barrel 39 of the fishing reel 38 to rotate, which, in turn, causes the connector 46 to rotate inside a connector sleeve 51. The indicator detent 48 mounted to the connector second end 49 then rotates as the connector 46 rotates so as to disengage the indicator detent 48 from the indicator 42, thereby allowing the indicator 42 to assume the signaling position 56. The marker 43, the mast 41, and the base 30 all incorporate a phosphorescent material 64.

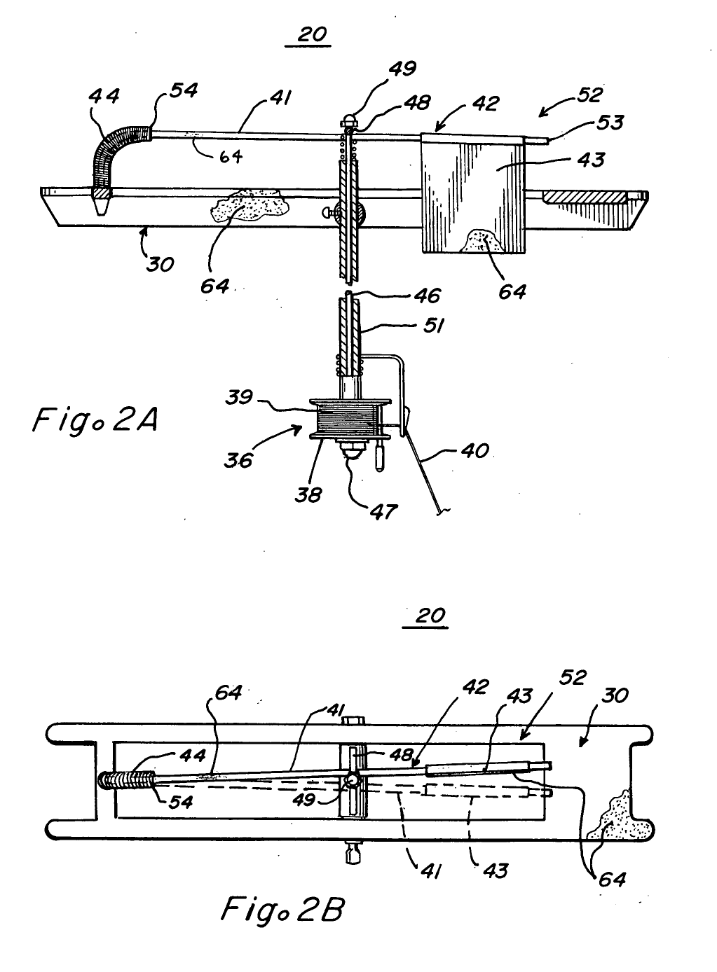

An embodiment having a circular base 30 is illustrated in FIGS. 3A and 3B. The indicator 42 is configured as a mast 41 with a marker 43 having the form of a flag secured to the mast first end 53. The marker 43 incorporates a phosphorescent material 64. A fishing line 40 is secured to the fishing line retention assembly 36. The fishing line retention assembly 36 is configured so as to have a rotatable member 39 that rotates in response to a force applied to the secured fishing line 40 by a fish. A connector 46 in the form of a shaft is secured at the connector first end 47 to the fishing line retention assembly 36 such that rotation of the rotatable member 39 causes rotation of the connector 46. Then, a force imparted to the fishing line 40 by a fish causes the rotatable member 39 of to rotate, which, in turn, causes the connector 46 to rotate. The indicator detent 48 mounted proximate to the connector second end 49. The indicator detent 48 then shifts position as the connector 46 rotates thereby disengaging from the indicator 42. Disengagement of the indicator detent 48 allows the indicator 42 to assume the signaling position 56, as illustrated in FIG. 3A. The indicator 42, in this embodiment, is configured as a mast 41 with a marker 43 having the form of a flag secured to the mast first end 53. The indicator 42, may be placed in the ready position by bending the mast 41 about the mast connector 44 and engaging the mast 41 with the indicator detent 48 so that the indicator detent 48 retains the indicator 42 in the ready position 52, as illustrated in FIG. 3B.

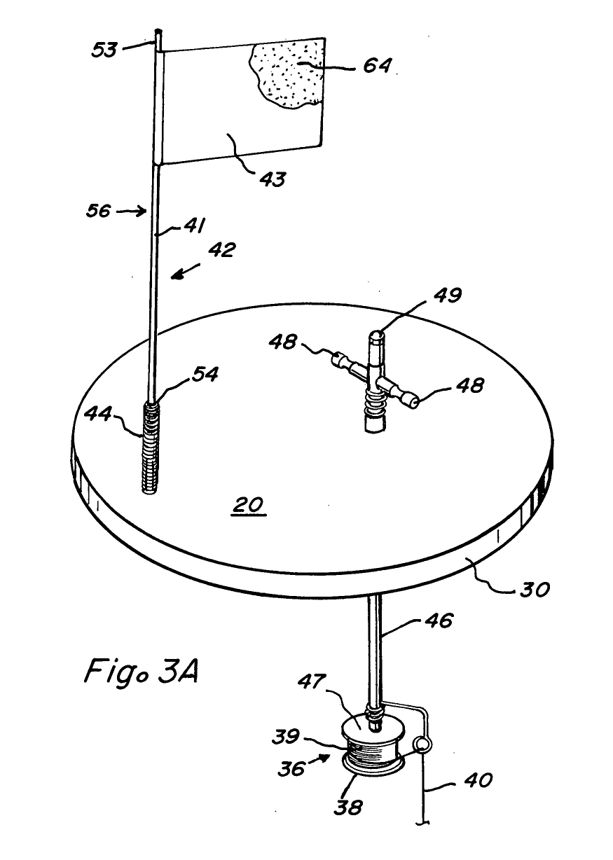

FIGS. 4A, 4B, and 4C show various indicators 42 where the indicators 42 are configured as masts 41 having a marker 43 secured generally at the mast first end 53. The marker may have different forms. For example, the marker 43 may be configured as a rectangular flag, the marker 43 may be configured as a pennant, and the marker 43 may be configured as a sphere, as illustrated in FIGS. 4A, 4B, and 4C, respectively. The illustrated markers 43 incorporate the phosphorescent material 64.

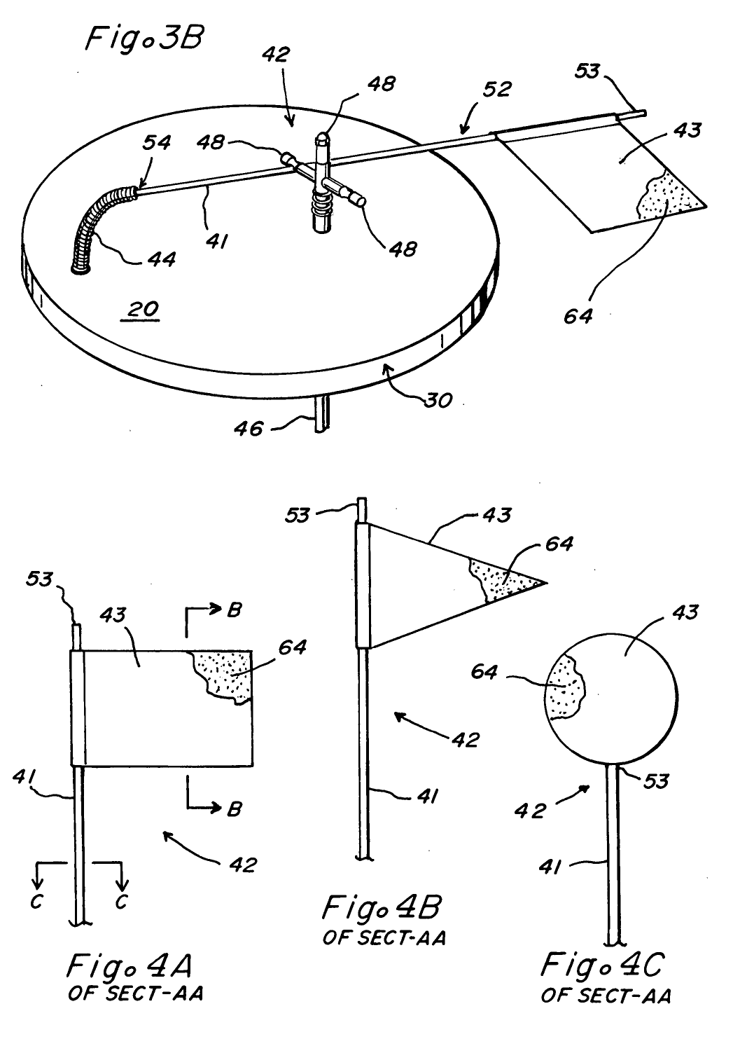

The phosphorescent material 64 may be incorporated into the indicator 42 and into the base 30. A cross-section of the base 30 is illustrated in FIGS. 5A-5D. In FIG. 5A, the base 30 is constructed of a non-phosphorescent material 78 such as wood or a non-phosphorescent polymer that is coated with a phosphorescent coating material 72.

In the embodiment of Figure SB, the base 30 is constructed of a non-phosphorescent material 78 that is coated with a phosphorescent coating material 72. The phosphorescent coating material 72 is coated with a translucent material 76 that may protect and preserve the phosphorescent coating material 72.

The embodiment illustrated in FIG. 5C has a base made of a phosphorescent polymer 68. A base constructed of a phosphorescent polymer 68 may also be coated with a translucent material 76, as illustrated in FIG. 5D.

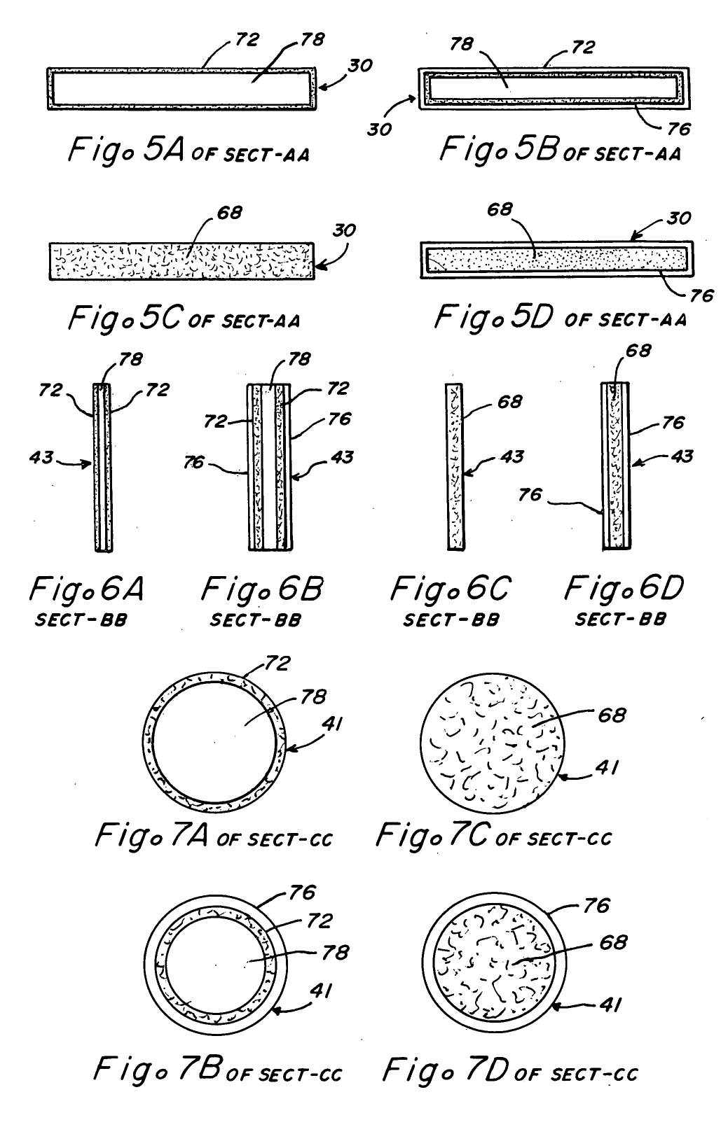

The phosphorescent material 64 may be incorporated into the indicator 42 in various ways as illustrated in the cross-sections presented in FIGS. 6A-6D and 7A-7D. For example, the marker 43 may be constructed of a non-phosphorescent material 78 that is coated with a phosphorescent coating material 72, as illustrated in FIG. 6A. The marker 43 may be constructed of a non-phosphorescent material 78 that is coated with a phosphorescent coating material 72 and then coated with a translucent material 76, as illustrated in FIG. 6B. The marker 43 may be constructed of a phosphorescent polymer 68, illustrated in FIG. 6C, which may be coated with a translucent material 76, as illustrated in FIG. 6D.

Other parts of the indicator may also incorporate phosphorescent material 64. Cross-sections of a mast 41 that incorporates a phosphorescent material 64 are illustrated in FIGS. 7A-7D. The mast 41 may be constructed of a non-phosphorescent material 78 that is coated with a phosphorescent coating material 72, as illustrated in FIG. 7A. The mast 41 may be constructed of a non-phosphorescent material 78 that is coated with a phosphorescent coating material 72 and then coated with a translucent material 76, as illustrated in FIG. 7B. The mast 41 may be constructed of a phosphorescent polymer 68, illustrated in FIG. 7C, which may then be coated with a translucent material 76, as illustrated in FIG. 7D.

The foregoing discussion discloses and describes merely exemplary embodiments of the present invention. It should be understood that no limitation of the scope of the invention is intended thereby. Upon review of the specification, one skilled in the art will readily recognize from such discussion, and from the accompanying drawings and claims, that various changes, modifications and variations can be made therein without departing from the spirit and scope of the inventions as defined in the following claims.

1. A signaling device for ice fishing, comprising:
a base configured to extend across at least a portion of a hole formed in ice, the base including a fishing line retention assembly;
an indicator secured to the base, the indicator being positionable between at least a ready position and a signaling position;
an indicator detent movably secured to the base to retain the indicator in at least a ready position, the indicator detent in communication with the fishing line retention assembly and configured to release the indicator to at least the signaling position in response to a force applied to the fishing line retention assembly; and,
a phosphorescent material, where at least a portion of the indicator includes the phosphorescent material.

2. The signaling device of claim 1, wherein at least a portion of the indicator is composed of a polymer, the polymer incorporating the phosphorescent material.

3. The signaling device of claim 1, wherein at least a portion of the indicator is coated with a phosphorescent coating material.

4. The signaling device as in claim 1, further comprising a translucent material conjoined to the phosphorescent material.

5. A signaling device for ice fishing, comprising:
a base configured to extend across at least a portion of a hole formed in ice, the base including a fishing line retention assembly;
an indicator secured to the base, the indicator being positionable between at least a ready position and a signaling position;
an indicator detent movably secured to the base to retain the indicator in at least a ready position, the indicator detent in communication with the fishing line retention assembly and configured to release the indicator to at least the partially signaling position in response to a force applied to the fishing line retention assembly; and,
a phosphorescent material, at least a portion of the indicator includes the phosphorescent material.

6. An apparatus, as in claim 5, further comprising a fishing line secured to the fishing line retention assembly of the base.

7. An apparatus, as in claim 5, further comprising a connector secured between the fishing line retention assembly and the indicator detent to communicate forces between the fishing line retention assembly and the indicator detent.

8. An apparatus, as in claim 7, further comprising the connector couples a fishing reel to the indicator detent such that rotation of the fishing reel causes the indicator detent to release the indicator into a signaling position.

9. The signaling device of claim 5, wherein at least a portion of the base is composed of a polymer, the polymer incorporating the phosphorescent material.

10. The signaling device of claim 5, wherein at-least a portion of the base is coated with coating material, the coating material incorporating a phosphorescent material.

11. The signaling device as in claim 5, further comprising a translucent material conjoined to the phosphorescent material.

12. A signaling device for ice fishing, comprising:
a base the base including a fishing line retention assembly;
indicator means secured to the base means for signaling the capture of a fish;
indicator detent means for retaining the indicator means in at least a ready position and releasing the indicator means to at least a signaling position in response to a force applied to the fishing line retention assembly, the indicator detent means secured to the base; and,
a phosphorescent material, at least a portion of the indicator means includes the phosphorescent material.

13. A signaling device for ice fishing, comprising:
a base configured to extend across at least a portion of a hole formed in ice, the base including a fishing line retention assembly;
an indicator secured to the base, the indicator being positionable between at least a ready position and a signaling position;
an indicator detent movably secured to the base to retain the indicator in at least a ready position, the indicator detent in communication with the fishing line retention assembly and configured to release the indicator to at least a signaling position in response to a force applied to the fishing line retention assembly; and,
a phosphorescent material, at least a portion of the base includes the phosphorescent material.

14. The signaling device of claim 13, further comprising at least a portion of the base is composed of a polymer, the polymer incorporating the phosphorescent material.

15. The signaling device of claim 13, further comprising at least a portion of the base is coated with a phosphorescent coating material.
